(19) United States
(12) Patent Application Publication
(10) Pub. No.: US 2016/0085713 A1
(43) Pub. Date: Mar. 24, 2016

(54) APPARATUS, SYSTEM AND METHOD OF WIRELESS DOCKING

(71) Applicant: INTEL CORPORATION, Santa Clara, CA (US)

(72) Inventors: Michael Glik, Kfar Saba (IL); Ophir Edlis, Modi'in-Maccabim-Re'ut (IL); Eran Sudak, Herzliya (IL); Tal Davidson, Holon (IL)

(21) Appl. No.: 14/492,038

(22) Filed: Sep. 21, 2014

(51) Int. Cl. G06F 13/40; H04W 4/00; H04W 76/02

(52) U.S. Cl. CPC G06F 13/4081; H04W 76/023; H04W 4/008; H04W 84/18

(57) ABSTRACT

Some demonstrative embodiments include an apparatus, method and/or system of wireless docking. For example, a docking device may include a radio to communicate with a mobile device; and a docking controller to instruct one or more user interface devices to output a docking interface, to receive one or more docking instructions via the docking interface, and, based on the docking instructions, to connect the user interface devices as peripheral devices to the mobile device via a wireless communication link between the radio and the mobile device.

### TECHNICAL FIELD

Embodiments described herein generally relate to wireless docking.

### BACKGROUND

Mobile devices are becoming smaller and smaller, and typically have decreasingly smaller screens and less Input/Output (JO) ports from generation to generation.

Docking stations are commonly used nowadays to extend the IO port array of the mobile devices, and provide a convenient means for a mobile device to hook up to a static variety of peripheral devices (“peripherals”), such as displays, monitors, external storage devices, external Hard Disk Drives (HDD), a mouse, keyboards, webcams, communication devices, and the like.

A docking device (also referred to as “docking station”) may typically be placed on a table, while being permanently connected to the peripherals, and a user of the mobile device may connect the mobile device to the docking station (“dock”) to utilize the peripherals.

A wireless docking device is a docking device, in which the user may connect the mobile device to the wireless docking device in a wireless manner.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic block diagram illustration of a docking display device, in accordance with some demonstrative embodiments.

FIG. 3 is a schematic illustration of a sequence diagram of operations performed by a docking device, one or more user interface devices, and a mobile device, in accordance with some demonstrative embodiments.

FIG. 4 is a schematic illustration of a sequence diagram of operations performed by a docking device, one or more user interface devices, and a mobile device, in accordance with some demonstrative embodiments.

FIG. 5 is a schematic flow chart illustration of a method of wireless docking, in accordance with some demonstrative embodiments.

FIG. 6 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a docking device, a docking station, a peripheral device, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing WiGig Display Extension (WDE) protocols (WDE Draft Specification 1.04, August 2012) and/or future versions and/or derivatives thereof, devices and/or networks operating in accordance with existing WiGig Bus Extension (WBE) protocols (WiGig Bus Extension Spec (WBE), Version 1.0 June 2011) and/or future versions and/or derivatives thereof, devices and/or networks operating in accordance with existing WiGig Secure Digital (SD) Extension (WSD) protocols (WiGig SD Extension (WSD) PAL Specification Draft 1.0 August 2012) and/or future versions and/or derivatives thereof, devices and/or networks operating in accordance with existing IEEE 802.11 standards ((IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (IEEE Standard for Information Technology—Telecommunications and information exchange between systems Local and metropolitan area networks—Specific requirements Part 11: Wireless LAN Medium Access Control (MAC) and Physical Layer (PHY) Specifications—Amendment 4: Enhancements for Very High Throughput for Operation in Bands below 6 GHz); IEEE 802.11ad (IEEE P802.11ad-2012, IEEE Standard for Information Technology —Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec., 2012)) and/or future versions and/or derivatives thereof, devices and/or networks operating in accordance with existing and/or Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

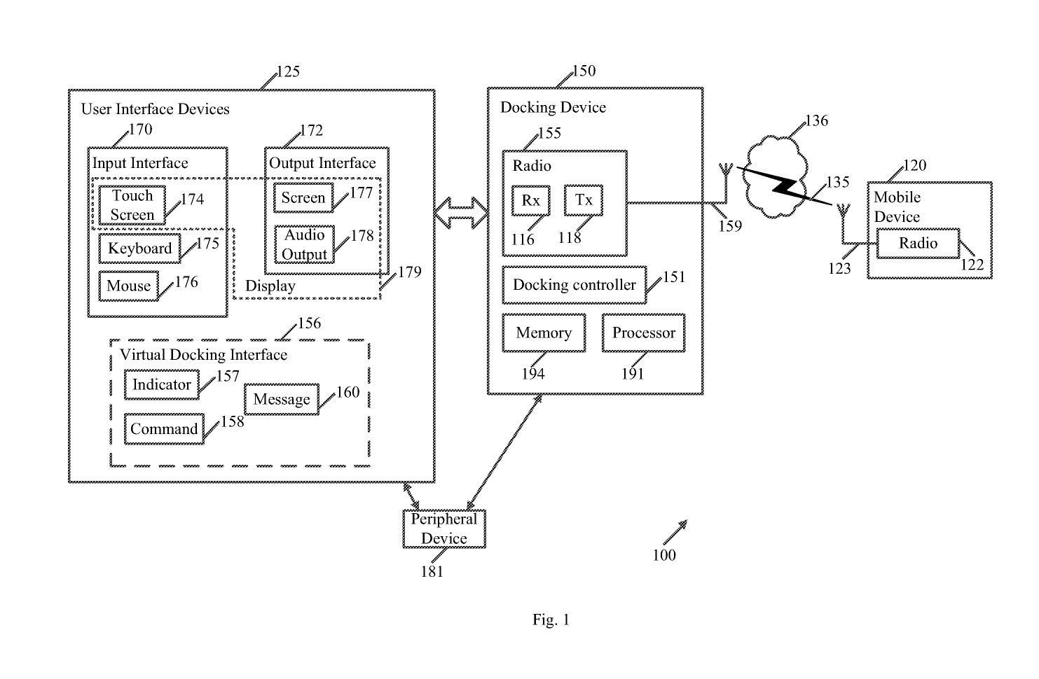

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via a wireless medium (WM) 136. For example, system 100 may include a mobile device 120 (also referred to as “client device”) and a wireless docking device 150 (also referred to as “docking station” or “Dock”).

In some demonstrative embodiments, wireless medium 136 may include, for example, a radio channel, a cellular channel, an RF channel, a Wireless Fidelity (WiFi) channel, an IR channel, and the like. One or more elements of system 100 may optionally be capable of communicating over any suitable wired communication links.

In some demonstrative embodiments, mobile device 120 and/or wireless docking device 150 may include one or more wireless communication units to perform wireless communication between mobile device 120, wireless docking device 150, and/or one or more other wireless communication devices. For example, wireless docking device 150 may include a radio 155, and/or mobile device 120 may include a radio 122.

In some demonstrative embodiments, radios 155 and/or 122 may include one or more wireless transmitters, receivers and/or transceivers able to send and/or receive wireless communication signals, RF signals, frames, blocks, transmission streams, packets, messages, data items, and/or data.

In some demonstrative embodiments, radio 155 and/or radio 122 may include one or more wireless receivers (Rx) 116, able to receive wireless communication signals, RF signals, frames, blocks, transmission streams, packets, messages, data items, and/or data.

In some demonstrative embodiments, radio 155 and/or radio 122 may include one or more wireless transmitters (Tx) 118, able to send wireless communication signals, RF signals, frames, blocks, transmission streams, packets, messages, data items, and/or data.

In some demonstrative embodiments, radios 155 and/or 122 may include modulation elements, demodulation elements, amplifiers, analog to digital and digital to analog converters, filters, and/or the like. For example, radios 155 and/or 122 may include or may be implemented as part of a wireless Network Interface Card (NIC), and the like.

In some demonstrative embodiments, radios 155 and 122 may be configured to establish a wireless communication link 135 between mobile device 120 and wireless docking device 150 over WM 136 to connect between mobile device 120 and wireless docking device 150.

In some demonstrative embodiments, wireless communication link 135 may include a millimeter-wave (mmwave) wireless communication link.

In some demonstrative embodiments, wireless communication link 135 may include a short-range wireless communication link at a multi-gigabit-per-second (MGbs) rate. For example, wireless communication link 135 may include a Wireless-Gigabit (WiGig) link.

In some demonstrative embodiments, wireless communication link 135 may include a peer-to-peer (P2P) communication link.

In some demonstrative embodiments, wireless communication link 135 may include a WiFi link.

In some demonstrative embodiments, wireless communication link 135 may include a Bluetooth link.

In other embodiments, wireless communication link 135 may include any other wireless communication link.

In some demonstrative embodiments, radios 155 and/or 122 may include, or may be associated with, one or more antennas. For example, radio 155 may be associated with one or more antennas 159, and/or radio 122 may be associated with one or more antennas 123.

Antennas 159 and/or 123 may include any type of antennas suitable for transmitting and/or receiving wireless communication signals, blocks, frames, transmission streams, packets, messages and/or data. For example, antennas 159 and/or 123 may include any suitable configuration, structure and/or arrangement of one or more antenna elements, components, units, assemblies and/or arrays. Antennas 159 and/or 123 may include, for example, antennas suitable for directional communication, e.g., using beamforming techniques. For example, antennas 159 and/or 123 may include a phased array antenna, a multiple element antenna, a set of switched beam antennas, and/or the like. In some embodiments, antennas 159 and/or 123 may implement transmit and receive functionalities using separate transmit and receive antenna elements. In some embodiments, antennas 159 and/or 123 may implement transmit and receive functionalities using common and/or integrated transmit/receive elements.

In some demonstrative embodiments, wireless docking device 150 may also include, for example, a processor 191, and/or a memory unit 194. Wireless docking device 150 may optionally include other suitable hardware components and/or software components. In some demonstrative embodiments, some or all of the components of wireless docking device 150 may be enclosed in a common housing or packaging, and may be interconnected or operably associated using one or more wired or wireless links. In other embodiments, components of wireless docking device 150 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of wireless docking device 150 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. For example, memory unit 194, for example, may store data processed by wireless docking device 150.

In some demonstrative embodiments, mobile device 120 may include, for example, a User Equipment (UE), a mobile computer, a laptop computer, a notebook computer, a tablet computer, an Ultrabook™ computer, a mobile internet device, a handheld computer, a handheld device, a storage device, a ^{P}DA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, wireless docking device 150 may be connected to, may include, or may be implemented as part of, one or more user interface devices 125, e.g., as described below.

In some demonstrative embodiments, user interface devices 125 may include one or more devices capable of performing the functionality of one or more peripheral devices, e.g., as described below.

In some demonstrative embodiments, user interface devices 125 may include one or more Human Interface Devices (HIDs), e.g., as described below.

In some demonstrative embodiments, user interface devices 125 may include one or more input interfaces 170 configured to receive input from a user. For example, input interfaces 170 may include a touch screen 174, a keyboard 175, a mouse 176, a touchpad (not shown in FIG. 1), an audio input, e.g., a microphone or any other audio sensor (not shown in FIG. 1), and/or any other input interface unit, or device.

In some demonstrative embodiments, user interface devices 125 may include one or more output interfaces 172 configured to provide an output to the user. For example, output interfaces 172 may include a screen 177, an audio output, e.g., a speaker 178 or any other audio transducer, and/or any other output interface unit, or device.

In some demonstrative embodiments, two or more of user interface devices 125 may be implemented as part of an integrated user input device. For example, touch screen 174, screen 177, and audio output 178 may be implemented as part of a display device 179, e.g., a docking display device. Display device 179 may include, for example, a monitor, a screen, a flat panel display, a Light Emitting Diode (LED) display unit, a Liquid Crystal Display (LCD) display unit, a plasma display unit, Cathode Ray Tube (CRT) display unit, and/or any other screen or display device.

In some demonstrative embodiments, docking device 150 may be connected to at least one other peripheral device (“peripheral”) 181, e.g., directly or via one or more of user interface devices 125. Peripheral device 181 may include, for example, a Universal Serial Bus (USB) hub, an external storage, and/or any other peripheral device. In one example, peripheral device 181 may include, for example, a storage device, which may be connected to display 179, e.g., via a USB port of display 179. In another example, peripheral device 181 may include, for example, a storage device, which may be connected directly to docking device 150, e.g., via a USB port of docking device 150.

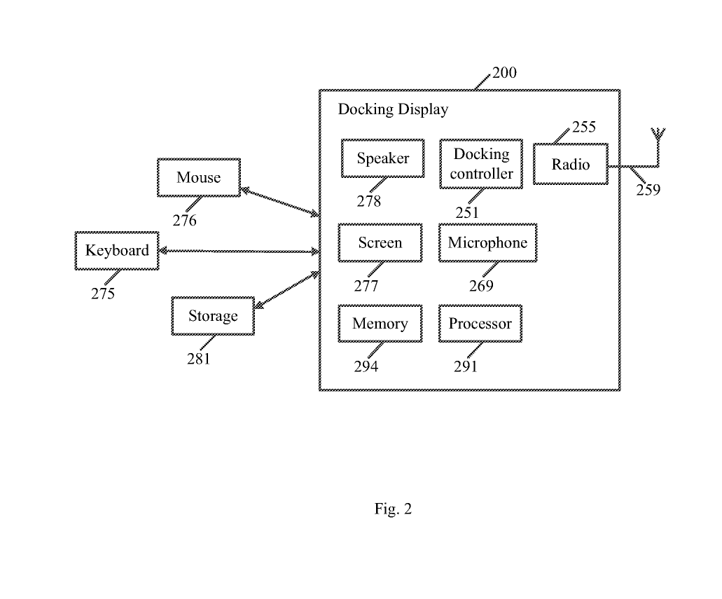

In some demonstrative embodiments, wireless docking device 150 may be implemented together with, or as part of, one or more of user interface devices 125 and/or peripheral device 181. In one example, wireless docking device 150 may be embedded and/or integrated as part of display 179, e.g., as described below with reference to FIG. 2.

In some demonstrative embodiments, one or more of user interface devices 125 and/or peripheral 181 may be implemented as a separate element, which may be connected to wireless docking device 150 via a wired or wireless connection. For example, wireless docking device 150 may include a wireless docking station, which may be connected to one or more of user interface devices 125, e.g., via one or more physical ports, e.g., USB ports, and/or one or more wireless connections.

In some demonstrative embodiments, wireless docking device 150 may be configured to provide one or more docking functionalities to a mobile device, e.g., mobile device 120, in a wireless manner. For example, wireless docking device 150 may enable mobile device 120 to connect to user interface devices 125 and/or peripheral 181, and to use one or more functionalities associated with user interface devices 125 and/or peripheral 181 in a wireless manner.

In one example, wireless docking device 150 may enable a user of mobile device 120 to view video content from mobile device 120 on display 126. For example, mobile device 120 may include a Smartphone, and wireless docking device 150 may connect the Smartphone to display 126, for example, to enable the user of mobile device 120 to watch a video, which may be stored by the Smartphone, on display 126.

In another example, mobile device 120 may include a Smartphone, and wireless docking device 150 may connect the Smartphone to keyboard 175 and/or mouse 176, for example, to enable the user of mobile device 120 to edit a file, which may be displayed on display 126, using the keyboard and/or the mouse.

In some demonstrative embodiments, docking device 150 may include a docking controller 151 to control one or more functionalities of docking device 150, e.g., as described below.

In some demonstrative embodiments, docking controller 151 may be configured to control setup, establishment, and/or teardown of a docking connection between mobile device 120 and one or more peripherals, e.g., one or more of user interface devices 125 and/or peripheral device 181.

In some demonstrative embodiments, docking device 150 may be configured to connect between mobile device 120 and user interface devices 125 and/or peripheral 181 over a WiGig Serial Extension (WSE) link, for example, to communicate data, e.g., files, with mobile device 120.

In some demonstrative embodiments, docking device 150 may be configured to connect between mobile device 120 and user interface devices 125 and/or peripheral 181 over a WiGig Display Extension (WDE), e.g., to communicate video and/or audio data between mobile device 120 and display 179.

In some demonstrative embodiments, docking device 150 may be configured to connect between mobile device 120 and user interface devices 125 and/or peripheral 181 over a WBE link, a WSD link and/or any other link.

In other embodiments, docking device 150 may be configured to connect between mobile device 120 and user interface devices 125 and/or peripheral 181 according to any other suitable wireless communication technology and/or protocol.

In some demonstrative embodiments, docking controller 151 may include circuitry, e.g., processor circuitry, memory circuitry, docking circuitry, Protocol Adaptation layer (PAL) circuitry, Media-Access Control (MAC) circuitry, Physical Layer (PHY) circuitry, and/or any other circuitry, configured to perform the functionality of docking controller 151, e.g., as described below. Additionally or alternatively, one or more functionalities of docking controller 151 may be implemented by logic, which may be executed by a machine and/or one or more processors, e.g., as described below.

In some demonstrative embodiments, docking controller 151 may be configured to use, control and/or instruct one or more of user interface devices 125 to perform the functionality of a virtual docking interface 156, e.g., as described below.

In some demonstrative embodiments, virtual docking interface 156 may be configured to interface between docking controller 151 and a user, e.g., to enable the user to interact with docking device 150 and/or to control one or more docking operations of docking device 150, e.g., as described below.

In some demonstrative embodiments, virtual docking interface 156 may be configured to provide a comprehensive, enhanced and/or intuitive user experience to the user of mobile device 120, when using wireless docking device 150, e.g., as described below.

In some demonstrative embodiments, virtual docking interface 156 may be configured to enable the user of mobile device 120 to perform one or more docking operations, and/or to receive an indication of one or more docking states of wireless docking device 150, e.g., as described below.

In some demonstrative embodiments, virtual docking interface 156 may be configured to indicate a plurality of predefined states of wireless docking device 150, and/or to trigger a predefined plurality of wireless docking operations 150, e.g., as described below.

In some demonstrative embodiments, virtual docking interface 156 may be configured to provide a user experience, which may be similar to a user experience provided by a physical docking interface, for example, a physical interface including one or more physical indicators and/or one or more physical command buttons, e.g., as described below.

In some demonstrative embodiments, virtual docking interface 156 may be configured to provide a user experience, which may be similar to a user experience provided by an interface of a wired docking device.

In some demonstrative embodiments, virtual docking interface 156 may be configured to interface between the user and docking device 150, for example, even without using one or more physical interface elements or devices, e.g., instead of one or more dedicated physical docking interface buttons and/or indicators.

In some demonstrative embodiments, docking interface 156 may be configured to enable, for example, integrating docking device 150 as part of a peripheral device, e.g., as part of display device 179, for example, while obviating a need to install dedicated interface hardware, e.g., indicators and/or buttons, on the peripheral device. According to these embodiments, virtual docking interface 156 may enable, for example, to reduce a cost and/or complexity of integrating docking device 150 as part of the peripheral device, e.g., compared to a cost of integrating into a monitor a wireless docking device, and dedicated docking interface command buttons and/or indicators, e.g., Light Emitting Diode (LED) indicators.

In some demonstrative embodiments, docking controller 151 may be configured to utilize user interface functionalities of user interface devices 125 to perform functionalities of virtual docking interface, e.g., as described below.

In some demonstrative embodiments, docking controller 151 may be configured to instruct one or more of user interface devices 125 to output docking interface 156, e.g., to the user of docking device 150, as described below.

In some demonstrative embodiments, docking controller 151 may be configured to instruct one or more of user interface devices 125 to output docking interface 156 by at least one of output interfaces 172, e.g., as described below.

In some demonstrative embodiments, docking controller 151 may be configured to receive one or more docking instructions via docking interface 156, e.g., as described below.

In some demonstrative embodiments, docking controller 151 may receive the docking instructions from at least one input interface 170, e.g., as described below.

In some demonstrative embodiments, docking controller 151 may be configured to connect one or more of user interface devices 125 as peripheral devices to mobile device 120 via wireless communication link 135, e.g., based on the docking instructions received via docking interface 156.

In some demonstrative embodiments, docking controller 151 may be configured to use an output functionality of output interfaces 172 to provide the user of docking device 150 with one or more outputs of virtual docking interface 156. For example, docking controller 151 may be configured to use a display functionality of screen 177 to provide to the user one or more visual outputs of virtual docking interface 156, and/or an audio functionality of audio output 178 to provide to the user one or more audio outputs of virtual docking interface 156,

In some demonstrative embodiments, docking controller 151 may be configured to use an input functionality of input interfaces 170 to receive from the user of docking device 150 one or more inputs to virtual docking interface 156. For example, docking controller 151 may be configured to use a input functionality of touch screen 174, keyboard 175 and/or mouse 176 to receive from the user one or more inputs to virtual docking interface 156, for example, one or more docking instructions. The docking instructions may include any one or more inputs, commands, instructions, to docking device 150, e.g., to setup, configure and/or control the docking connection with mobile device 120.

In some demonstrative embodiments, virtual docking interface 156 may include one or more indicators 157 to indicate a docking state of docking device 150.

In some demonstrative embodiments, indicators 157 may include for example, at least one indicator configured to indicate, for example, a ready to connect state, a connected state, a disconnected state, a paired state, a paring in progress state, an error state, and/or any other state, mode and/or operation.

In some demonstrative embodiments, docking controller 151 may instruct one or more of user interface devices 125 to output one or more indicators 157 of output docking interface 156 via one or more of output interfaces 172.

In some demonstrative embodiments, indicators 157 may include one or more visual indicators. For example, docking controller 151 may instruct one or more of user interface devices 125 to output a visual indicator 157 via screen 177.

In some demonstrative embodiments, indicators 157 may include a visual representation of one or more LED indicators. For example, indicators 157 may include a visual representation of a red LED, e.g., to indicate a first docking state, a visual representation of a yellow LED, e.g., to indicate a second docking state, a visual representation of a green LED, e.g., to indicate a third docking state, a visual representation of a blue LED, e.g., to indicate a fourth docking state, and/or any other visual indicator representation.

In some demonstrative embodiments, indicators 157 may include one or more audio indicators. For example, docking controller 151 may instruct one or more of user interface devices 125 to output an audio indicator 157 via audio output 178. In one example, the audio indicator may include a sound, e.g., beep, a ring, or any other sound, configured to indicate a docking state. In another example, the audio indicator may include an audio message, e.g., a voice message, to announce a docking state.

In some demonstrative embodiments, virtual docking interface 156 may be configured to output one or more docking messages 160.

In some demonstrative embodiments, docking messages 160 may include for example, a “ready to connect” message to inform the user that docking device 150 is ready to connect to a mobile device; an instruction message, for example, a pairing instruction message to instruct the user to perform one or more pairing operation, e.g., to push a pairing button on mobile device 120; an information message to provide information to the user, for example, an error message, e.g., to inform the user of an error, and/or any other message.

In some demonstrative embodiments, docking controller 151 may instruct one or more of user interface devices 125 to output one or more messages 160 of output docking interface 156 via one or more of output interfaces 172.

In some demonstrative embodiments, docking messages 160 may include one or more visual messages. For example, docking controller 151 may instruct one or more of user interface devices 125 to output a visual message 160 via screen 177.

In some demonstrative embodiments, messages 160 may include a text message, an image message, a video message, and/or any other type of visual message.

In some demonstrative embodiments, docking messages 160 may include one or more audio messages. For example, docking controller 151 may instruct one or more of user interface devices 125 to output an audio message 160 via audio output 178. In one example, the audio indicator may include an audio message, for example, a voice message, e.g., an audio pairing message “please activate pairing at the mobile device”, an audio connect message “mobile device has been successfully connect to dock”, an audio disconnect message “mobile device has been disconnected from dock”, or any other message.

In some demonstrative embodiments, virtual docking interface 156 may include one or more command buttons 158 to receive one or more docking instructions from the user.

In some demonstrative embodiments, command buttons 158 may include for example, a pairing button to instruct docking controller 151 to perform a pairing operation, e.g., as described below, a connect button to instruct docking controller 151 to establish a docking connection, disconnect button to instruct docking controller 151 to disconnect a docking connection, a reset button to instruct docking controller 151 to reset docking device 150, and/or any other button to instruct docking controller 151 to perform any other operation.

In some demonstrative embodiments, docking controller 151 may instruct one or more of user interface devices 125 to output one or more command buttons 158 of output docking interface 156 via one or more of output interfaces 172.

In some demonstrative embodiments, command buttons may include one or more visual buttons. For example, docking controller 151 may instruct one or more of user interface devices 125 to output a command buttons 158 via screen 177.

In some demonstrative embodiments, command buttons 158 may include a visual representation of a command button, e.g., a button switchable between two states, e.g., an “on” state and an “off” state, a command button switchable between three or more states, a slide button, a switch button, and/or any other button.

In some demonstrative embodiments, command buttons 158 may include a visual representation of any other command interface, e.g., a selection box, a menu, a drop-down menu, and the like.

In some demonstrative embodiments, docking controller 151 and virtual docking interface 156 may be configured to perform one or more pairing operations to pair between docking device 150 and mobile device 120, e.g., as described below.

In some demonstrative embodiments, docking controller 151 may be configured to receive a pairing instruction via virtual docking interface 156, e.g., via a command button 158, and, responsive to the pairing instruction, to pair between docking device 150 and mobile device 120, e.g., as described below.

In some demonstrative embodiments, the pairing operations may be configured to enable associating between wireless docking device 150 and mobile device 120, e.g., in a wireless manner.

In one example, the pairing between docking device 150 and mobile device 120 may include pairing according to a Wireless Protected Setup (WPS) protocol. In another example, the pairing between docking device 150 and mobile device 120 may include pairing a Pre-Shared-Key (PSK) passphrase pairing, or any other pairing method or protocol.

In some demonstrative embodiments, during the pairing between mobile device 120 and wireless docking device 150 the user of mobile device 120 may perform one or more operations on wireless docking device 150 and/or on mobile device 120.

In one example, the user of mobile device 120 may enter a unique Personal Identification Number (PIN) or a predefined pass-phrase to mobile device 120 to pair between mobile device 120 and wireless docking device 150.

In another example, wireless docking device 150 may be configured to support a push-button pairing, in which the user of mobile device 120 may push a button on both wireless docking device 150 and mobile device 120, e.g., a pairing command button 158 of virtual docking interface 156.

In another example, the pairing between wireless docking device 150 and mobile device 120 may include any other pairing method and/or protocol.

In some demonstrative embodiments, docking controller 151 may be configured to instruct user interface devices 125 to perform the functionality of virtual docking interface 156, for example, to interface between docking device 150 and the user, e.g., as described above.

In some demonstrative embodiments, docking controller 151 may switch user interface device 125 to perform the functionality of peripheral devices being docked to mobile device 120, for example, upon establishing the docking connection between mobile 120 and docking device 150.

In some demonstrative embodiments, docking controller 151 may configure docking device 150 to instruct one or more of user interface devices 125 to provide the functionality of virtual docking interface 156. In one example, docking controller may exclusively control the functionality of one or more of touch screen 174, screen 177, and/or audio output 178, for example, to provide the functionality of virtual docking interface 156, e.g., prior to establishing a docking connection with mobile device 120.

In some demonstrative embodiments, docking controller 151 may configure docking device 150 to operate in a mode of operation (“simple mode”), in which docking device 150 may transfer a management of the user interface devices 125 to mobile device 120, e.g., upon establishment of the docking connection with mobile device 120. In one example, once mobile device 120 has been authorized and connected to docking device 150, docking controller 151 may, for example, logically “disconnect” user interface devices 125 from docking device 150, and switch user interface devices 125 to be managed, e.g., exclusively, by mobile device 120, as peripheral devices. According to these embodiments, docking controller 151 may control communications between mobile device and user interface devices 125 over a direct docking connection via wireless link 135. According to these embodiments, one or more docking management operations of the docking connection may be performed, for example, via an application on mobile device 120.

In some demonstrative embodiments, docking controller 151 may be configured to switch the user interface devices 125 to perform the functionality of the virtual docking interface 156, for example, upon disconnection of wireless communication link 135, e.g., when mobile device 120 disconnects from docking device 150. For example, docking controller 151 may logically reconnect user interface devices 125 to docking device 150, e.g., once mobile device 120 disconnects from docking device 150.

In some demonstrative embodiments, docking controller 151 may configure docking device 150 to operate in a mode of operation (“snooping mode”), in which docking device 150 may maintain management of the user interface devices 125, e.g., even after establishment of the docking connection with mobile device 120.

In some demonstrative embodiments, docking controller 151 may be configured monitor user input to at least one of the user interface devices 125 being functional as the peripheral devices of mobile device 120. For example, docking controller 151 may monitor, e.g., by snooping or sniffing, communications between user interface devices 125 and mobile device 120, e.g., via the docking connection going through docking device 150.

In some demonstrative embodiments, docking controller 151 may be configured to switch the user interface devices 125 to perform the functionality of virtual docking interface 156, for example, based on the monitored user input.

In one example, docking controller 151 may monitor the user input to detect one or more predefined types of user input (“events”), which may be configured to indicate that the user of mobile device 120 wishes to switch from operating user interface devices 125 as peripherals of mobile device 120 to operating user interface devices 125 as virtual docking interface 156. In one example, a sequence of two quick taps on touch screen 174 may be defined to trigger the switching to virtual docking interface 156. In another example, a predefined combination of keys being pressed on keyboard 175, e.g., a combination “Control+Alt+V”, may be defined to trigger the switching to virtual docking interface 156.

Reference is made to FIG. 2, which schematically illustrates a docking display device 200, in accordance with some demonstrative embodiments. In some demonstrative embodiments, docking display device 200 may perform the functionality of a docking device, e.g., device 150 (FIG. 1), integrated as part of a display device, e.g., display device 179 (FIG. 1).

In some demonstrative embodiments, docking display device 200 may include one or more user interfaces, e.g., one or more of user interface devices 125 (FIG. 1). For example, docking display device 200 may include a screen 277, a speaker 278, and/or a microphone. For example, screen 277 may perform the functionality of screen 177 (FIG. 1), and/or speaker 278 may perform the functionality of audio output 178 (FIG. 1).

In some demonstrative embodiments, screen 277 may also perform the functionality of touch screen 174 (FIG. 1). In other embodiments, screen 277 may include any other type of screen.

In some demonstrative embodiments, docking display device 200 may include a radio 255 to communicate with a mobile device, e.g., mobile device 120 (FIG. 1), via one or moiré antennas 259. In one example, radio 255 may perform the functionality of radio 155 (FIG. 1), and/or antennas 259 may perform the functionality of antennas 259 (FIG. 1).

In some demonstrative embodiments, docking display device 200 may include a docking controller 251 to dock the mobile device to one or more peripheral devices. In one example, docking controller 251 may perform the functionality of docking controller 151 (FIG. 1).

In some demonstrative embodiments, docking controller 251 may be integrated as part of docking display device 200. In one example, docking controller 251 may be implemented as part of a docking control chip, e.g., a docking control System on Chip (SIC), as part of an Operating system (OS) of docking display device 200, and/or as part of any other element of docking display device 200.

In some demonstrative embodiments, docking display device 200 may include a memory 294, a processor 291, and/or any other element or unit. For example, memory 294 may perform the functionality of memory 194 (FIG. 1), and/or processor 291 may perform the functionality of processor 191 (FIG. 1).

In some demonstrative embodiments, docking controller 251 may be configured to dock the mobile device, e.g., mobile device 120 (FIG. 1), to one or more of the user interfaces of docking display device 200, e.g., screen 277, speaker 278, and/or microphone 269, and/or to one or more external devices, e.g., a mouse 276, a keyboard 275, and/or a storage device 281. For example, mouse 276 may perform the functionality of mouse 176 (FIG. 1), keyboard 275 may perform the functionality of keyboard 175 (FIG. 1), and/or storage 281 may perform the functionality of peripheral device 1812 (FIG. 1).

In some demonstrative embodiments, docking display device 200 may include one or more connectors, e.g., USB connectors or any other connectors, to connect to mouse 276, keyboard 275 and/or storage 281.

In some demonstrative embodiments, docking display device 200 may connect to mouse 276, keyboard 275 and/or storage 281 via any wireless interface connection, e.g., as described above.

In some demonstrative embodiments, docking controller 251 may be configured to control screen 277 to display a virtual docking interface, for example, virtual docking interface 156 (FIG. 1), e.g., as described above.

In some demonstrative embodiments, docking controller 251 may be configured to receive one or more docking instructions via the virtual docking interface. For example, docking controller 251 may receive one or more docking instructions via command buttons 158 (FIG. 1), e.g., as described above. For example, the docking instructions may be input by a user via mouse 276, keyboard 275, screen 277 and/or microphone 269, e.g., as described above with reference to FIG. 1.

In some demonstrative embodiments, docking controller 251 may be configured to control a docking connection between the mobile device, e.g., mobile device 120 (FIG. 1), and one or more peripherals via a wireless link between the mobile device and radio 255. For example, docking controller 251 may be configured to control a docking connection between mobile device 120 (FIG. 1) and screen 277, speaker 278, microphone 269, mouse 276, keyboard 275, and/or storage 281, e.g., as described above with reference to FIG. 1.

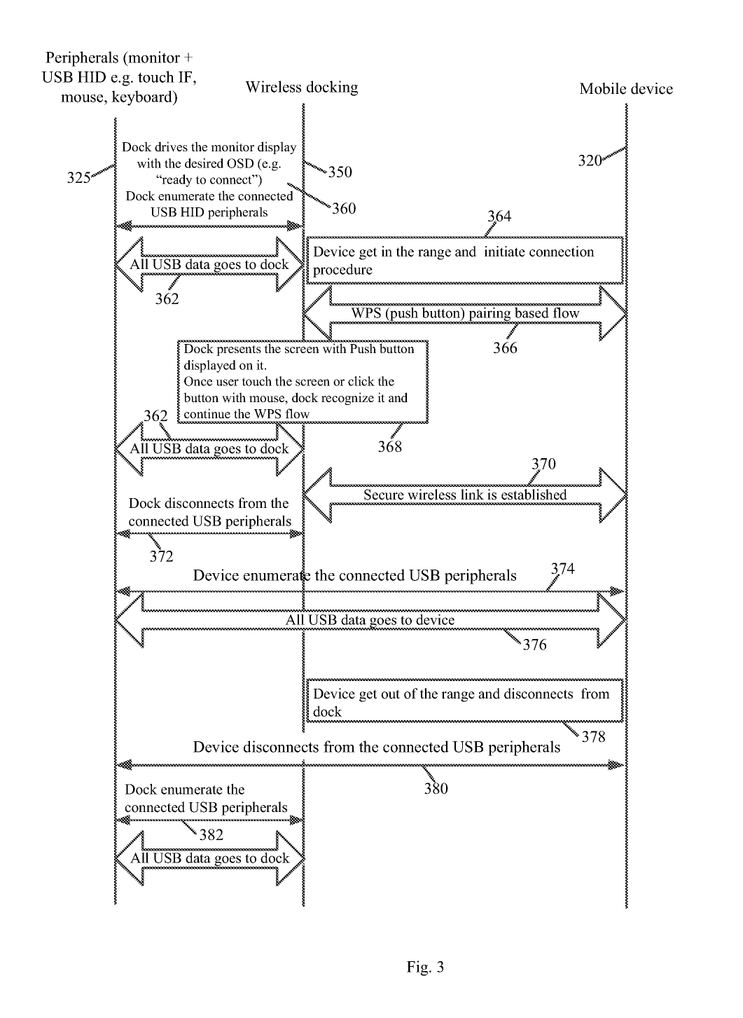

FIG. 3 is a schematic illustration of a sequence diagram of operations performed by a docking device 350, one or more user interface devices 325, and a mobile device 320, in accordance with some demonstrative embodiments. In some demonstrative embodiments, docking device 350 may perform the functionality of docking device 150 (FIG. 1), user interface devices 325 may perform the functionality of user interface devices 125 (FIG. 1), and/or mobile device 320 may perform the functionality of mobile device 120 (FIG. 1).

In some demonstrative embodiments, docking device 350 may instruct one or more of user interface devices to output a virtual docking interface.

For example, as shown in FIG. 3, docking device 350 may instruct at least one of user interface devices 325 to output at least one message 360, e.g., a ready to connect message, a welcome message, and/or any other message. For example, docking device 350 may instruct at least one of user interface devices 325 to output an On Screen Display (OSD) message, e.g., message 160 (FIG. 1), indicating that docking device 350 is ready to connect to a mobile device.

In some demonstrative embodiments, docking device 350 may control the virtual docking interface to include a configuration interface to configure the virtual docking interface, e.g., using one or more toggles, a settings button, a setting menu, and the like.

In some demonstrative embodiments, docking device 350 may the virtual docking interface, for example, responsive to one or more inputs from user interface devices 325, e.g., a mouse click, a keyboard press or touch, a tap on a touch screen, and the like.

In some demonstrative embodiments, docking device 350 may update the virtual docking interface, for example, based on one or more inputs detected by the user interface devices 325, e.g., if a toggle is clicked, docking device 350 may update the virtual docking interface to show a “V” mark next to the toggle. Additionally or alternatively, docking device 350 may update one or more functionalities of docking device, for example, based on one or more inputs detected by the user interface devices 325, e.g., if the clicked toggle is to affect one or more dock setting, for example, to enable or disable an auto connect feature.

In some demonstrative embodiments, docking device 350 may control (362) the user interface devices 325, e.g., to provide to docking device 350 all inputs received by user interface devices 325.

In some demonstrative embodiments, docking device 350 may detect (364) mobile device 320, e.g., when mobile device 320 is moved within a detection range of docking device 350.

In some demonstrative embodiments, docking device 350 and mobile device 320 may perform a pairing procedure 366 to pair mobile device 320 with docking device 350.

In some demonstrative embodiments, docking device 350 may utilize (368) the virtual docking interface to interface with a user during the pairing procedure. For example, docking device 350 may drive an OSD with a virtual “pair” button displayed on a screen. Docking device 350 may commence in the pairing process, for example, upon pressing of the virtual button pairing button, for example, by one of user interface devices 325, e.g., by a mouse click, pressing a key on a keyboard, or tapping the touch screen.

In some demonstrative embodiments, docking device 350 may establish (370) a secure wireless link with mobile device 320, e.g., subsequent to paring with mobile device 320.

In some demonstrative embodiments, docking device 350 may connect the user interface devices 325 as peripheral devices of the mobile device 320.

For example, as shown in FIG. 3, docking device 350 may logically disconnect (372) from user interface devices 325, and may logically connect (374) the user interface devices 325 to mobile device 320. In one example, docking device 350 may relinquish all user interface devices 325, and may route (378) all communication with the user interface devices 325 to mobile device 320, e.g., in a transparent manner, via the wireless link between docking device 350 and mobile device 320, e.g. over a WSE stack, a Media-Agnostic USB (MA-USB) stack, a WDE stack, a Miracast stack, or any other stack.

In some demonstrative embodiments, mobile device 320 may be disconnected (378) from docking device 350, and docking device 350 may resume control over the user interface devices 325, e.g., by disconnecting (380) the user interface devices 325 from mobile device 320, and connecting the user interface devices 325 back to docking controller 350.

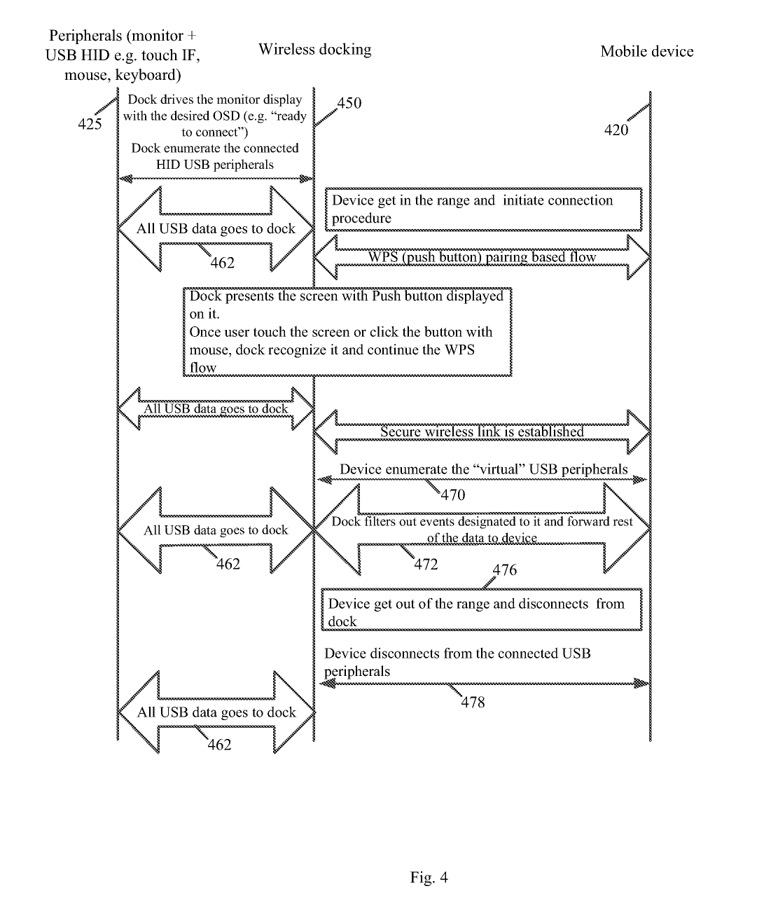

FIG. 4 is a schematic illustration of a sequence diagram of operations performed by a docking device 450, one or more user interface devices 425, and a mobile device 420, in accordance with some demonstrative embodiments. In some demonstrative embodiments, docking device 450 may perform the functionality of docking device 150 (FIG. 1), user interface devices 425 may perform the functionality of user interface devices 125 (FIG. 1), and/or mobile device 420 may perform the functionality of mobile device 120 (FIG. 1).

As shown in FIG. 4, docking device 450 may instruct user interface devices 425 to provide a virtual docking interface, may receive one or more docking instructions via the virtual docking interface, and may establish a docking connection between mobile device 320 and user interface devices 425, e.g., as described above with reference to FIG. 3.

In some demonstrative embodiments, one or more of the operations of FIG. 4 may be implemented by docking device 450 to enable docking device to maintain control (462) of user interface devices 425, e.g., to receive from user interface devices 425 all inputs received by user interface devices 425, for example, even during the docking connection with mobile device 420, e.g., at a snooping mode of operation.

In some demonstrative embodiments, docking device 450 may provide a virtual instance (470) of user interface devices 425 to mobile device 425. For example, docking device 450 may emulate a functionality of user interface devices 425 to mobile device 420m, e.g., while maintaining direct communication with and control over user interface devices 425.

In some demonstrative embodiments, docking device 450 may act as a “man in the middle”, for example, between user interface devices 425 and mobile device 420. For example, docking device 450 may snoop traffic between user interface devices 425 and mobile device 420, and may selectively (476) transfer some of the traffic to mobile device 420, while filtering out traffic intended for docking device 450. For example, docking device 450 may monitor user input from user input devices 425, for example, to detect at least event configured to trigger a switch to the virtual docking interface, e.g., as described above.

In one example, docking device 450 may be configured to react to a unique sequence of taps on the touch screen. According to this example, docking device 450 may continuously monitors the traffic stream of user interface devices 425, and upon identifying the predefined sequence of taps, docking device 450 may switch the user interface devices 425 to provide the virtual docking interface, for example, by displaying an overlay control menu, e.g., an OSD, over a current image from the mobile device 420. According to this example, the user of mobile device 420 may use the virtual docking interface to manipulate docking device 450, for example, to manually force docking device 450 to disconnect from the mobile device 420, e.g., using a button 158 (FIG. 1) overlaid on the display.

In some demonstrative embodiments, mobile device 420 may be disconnected (476) from docking device 450, and docking device 450 may disconnect (478) the user interface devices 425 from mobile device 420, e.g., by terminating the virtual emulation of user interface devices 425.

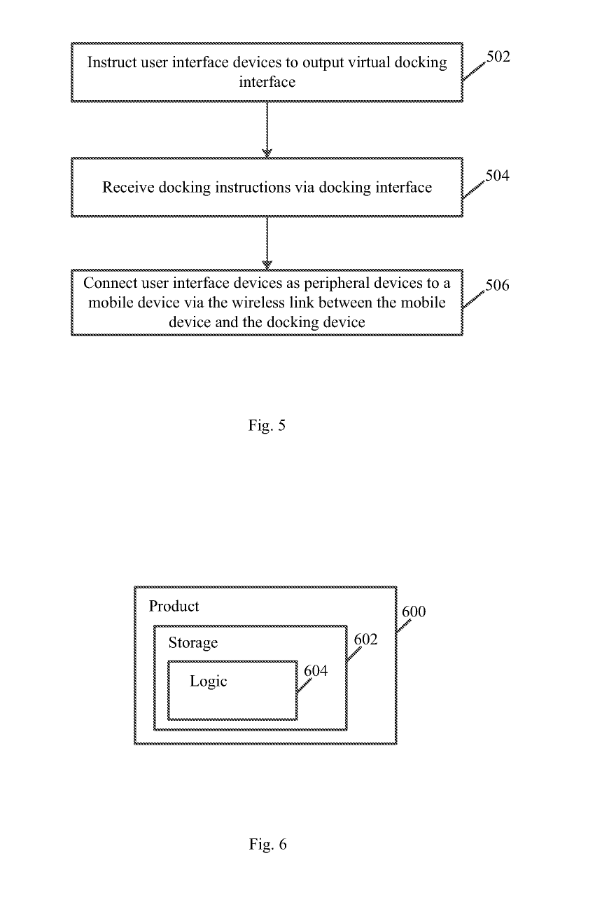

FIG. 5 is a schematic flow chart illustration of a method of wireless docking, in accordance with some demonstrative embodiments. For example, one or more of the operations of the method of FIG. 5 may be performed by a wireless communication system, e.g., system 100 (FIG. 1); a wireless docking device, e.g., wireless docking device 150 (FIG. 1); and/or a controller, e.g., docking controller 151 (FIG. 1).

As indicated at block 502, the method may include instructing one or more user interface devices to output a docking interface. For example, docking controller 151 (FIG. 1) may instruct one or more of user interface devices 125 (FIG. 1) to provide the functionality of virtual docking interface 156 (FIG. 1), e.g., as described above.

As indicated at block 504, the method may include receiving one or more docking instructions via the docking interface. For example, docking controller 1521 (FIG. 1) may receive one or more docking instructions, e.g., from the user of docking device 150, via virtual docking interface 156 (FIG. 1), for example, via one or more inputs to user input devices 125 (FIG. 1), e.g., as described above.

As indicated at block 506, the method may include connecting the user interface devices as peripheral devices to a mobile device via a wireless communication link between the docking device and the mobile device, e.g., based on the docking instructions. For example, docking controller 151 (FIG. 1) may connect user interface devices 125 (FIG. 1) as peripheral devices to mobile device 120 (FIG. 1) via wireless communication link 135 (FIG. 1), for example, based on instructions received via virtual docking interface 156 (FIG. 1), e.g., as described above.

Reference is made to FIG. 6, which schematically illustrates a product of manufacture 600, in accordance with some demonstrative embodiments. Product 600 may include a non-transitory machine-readable storage medium 602 to store logic 604, which may be used, for example, to perform at least part of the functionality of docking device 150 (FIG. 1), docking controller 151 (FIG. 1), docking controller 251 (FIG. 2), and/or to perform one or more operations of the method of FIG. 5. The phrase “non-transitory machine-readable medium” is directed to include all computer-readable media, with the sole exception being a transitory propagating signal.

In some demonstrative embodiments, product 600 and/or machine-readable storage medium 602 may include one or more types of computer-readable storage media capable of storing data, including volatile memory, non-volatile memory, removable or non-removable memory, erasable or non-erasable memory, writeable or re-writeable memory, and the like. For example, machine-readable storage medium 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a wireless docking device comprising a radio to communicate with a mobile device; and a docking controller to instruct one or more user interface devices to output a docking interface, to receive one or more docking instructions via the docking interface, and, based on the docking instructions, to connect the user interface devices as peripheral devices to the mobile device via a wireless communication link between the radio and the mobile device.

Example 2 includes the subject matter of Example 1, and optionally, wherein the docking controller is to instruct the one or more user interface devices to perform the functionality of the docking interface, and, upon connection to the mobile device, to switch the interface devices to perform the functionality of the peripheral devices.

Example 3 includes the subject matter of Example 2, and optionally, wherein the docking controller is to monitor user input to at least one of the peripheral devices, and, based on the user input, to switch the user interface devices to perform the functionality of the docking interface.

Example 4 includes the subject matter of Example 2 or 3, and optionally, wherein the docking controller is to switch the user interface devices to perform the functionality of the docking interface, upon disconnection of the wireless communication link.

Example 5 includes the subject matter of any one of Examples 1-4, and optionally, wherein the docking controller is to receive a pairing instruction via the docking interface, and, responsive to the pairing instruction, to pair between the docking device and the mobile device.

Example 6 includes the subject matter of any one of Examples 1-5, and optionally, wherein the docking controller is to receive the docking instructions from at least one input interface of the one or more user interface devices.

Example 7 includes the subject matter of Example 6, and optionally, wherein the at least one input interface comprises at least one interface selected from the group consisting of a keyboard, a mouse, a touch screen, and a touchpad.

Example 8 includes the subject matter of any one of Examples 1-7, and optionally, wherein the docking controller is to instruct the one or more user interface devices to output the docking interface by at least one output interface of the one or more user interface devices.

Example 9 includes the subject matter of Example 8, and optionally, wherein the docking controller is to instruct the output interface to output one or more docking messages.

Example 10 includes the subject matter of Example 8 or 9, and optionally, wherein the at least one output interface comprises at least one interface selected from the group consisting of a display, and an audio output unit.

Example 11 includes the subject matter of any one of Examples 1-10, and optionally, wherein the one or more user interface devices comprise a display, the docking controller to instruct the display to display the docking interface.

Example 12 includes the subject matter of Example 11, and optionally, wherein the docking interface comprises one or more indicators to indicate a docking state of the docking device.

Example 13 includes the subject matter of Example 11 or 12, and optionally, wherein the docking interface comprises at least one command button, the docking controller to control the docking device based on a state of the command button.

Example 14 includes the subject matter of Example 13, and optionally, wherein the at least one command button comprises at least one button selected from the group consisting of a pairing button, a connect button, and a disconnect button.

Example 15 includes the subject matter of any one of Examples 11-14, and optionally, wherein the display comprises a touch screen, the docking interface to receive the docking instructions via the touch screen.

Example 16 includes the subject matter of any one of Examples 11-15, and optionally, wherein the docking controller to instruct the display to display a ready to connect message.

Example 17 includes the subject matter of any one of Examples 1-16, and optionally, wherein the one or more user interface devices comprise one or more Human Interface Devices (HID).

Example 18 includes the subject matter of any one of Examples 1-17 being integrated as part of one of the one or more user interface devices.

Example 19 includes the subject matter of any one of Examples 1-18, and optionally, comprising one or more antennas; a memory; and a processor.

Example 20 includes a docking display device comprising a screen; one or more antennas; a radio to communicate with a mobile device; and a docking controller to control the screen to display a virtual docking interface, to receive one or more docking instructions via the virtual docking interface, and, based on the one or more docking instructions to connect the docking display device as a peripheral device to the mobile device via a wireless communication link between the radio and the mobile device.

Example 21 includes the subject matter of Example 20, and optionally, wherein the docking controller is to instruct one or more user interface devices to perform the functionality of the docking interface, and, upon connection to the mobile device, to switch the interface devices to perform the functionality of peripheral devices.

Example 22 includes the subject matter of Example 21, and optionally, wherein the docking controller is to monitor user input to at least one of the peripheral devices, and, based on the user input, to switch the user interface devices to perform the functionality of the docking interface.

Example 23 includes the subject matter of Example 21 or 22, and optionally, wherein the docking controller is to switch the user interface devices to perform the functionality of the docking interface, upon disconnection of the wireless communication link.

Example 24 includes the subject matter of any one of Examples 20-23, and optionally, wherein the docking controller is to receive a pairing instruction via the docking interface, and, responsive to the pairing instruction, to pair between the docking display device and the mobile device.

Example 25 includes the subject matter of any one of Examples 20-24, and optionally, wherein the docking controller is to receive the docking instructions from at least one input interface.

Example 26 includes the subject matter of Example 25, and optionally, wherein the at least one input interface comprises at least one interface selected from the group consisting of a keyboard, a mouse, a touch screen, and a touchpad.

Example 27 includes the subject matter of any one of Examples 20-26, and optionally, wherein the docking controller is to instruct the screen to display one or more docking messages of the docking interface.

Example 28 includes the subject matter of any one of Examples 20-27, and optionally, wherein the docking interface comprises one or more indicators to indicate a docking state of the docking device.

Example 29 includes the subject matter of any one of Examples 20-28, and optionally, wherein the docking interface comprises at least one command button, the docking controller to control the docking display device based on a state of the command button.

Example 30 includes the subject matter of Example 29, and optionally, wherein the at least one command button comprises at least one button selected from the group consisting of a pairing button, a connect button, and a disconnect button.

Example 31 includes the subject matter of any one of Examples 20-30, and optionally, wherein the screen comprises a touch screen, the docking interface to receive the docking instructions via the touch screen.

Example 32 includes a method of wireless docking to be performed at a docking device, the method comprising instructing one or more user interface devices to output a docking interface; receiving one or more docking instructions via the docking interface; and based on the docking instructions, connecting the user interface devices as peripheral devices to a mobile device via a wireless communication link between the docking device and the mobile device.

Example 33 includes the subject matter of Example 32, and optionally, comprising instructing the one or more user interface devices to perform the functionality of the docking interface, and, upon connection of the docking device to the mobile device, switching the interface devices to perform the functionality of the peripheral devices.

Example 34 includes the subject matter of Example 33, and optionally, comprising monitoring user input to at least one of the peripheral devices, and, based on the user input, switching the user interface devices to perform the functionality of the docking interface.

Example 35 includes the subject matter of Example 33 or 34, and optionally, comprising switching the user interface devices to perform the functionality of the docking interface, upon disconnection of the wireless communication link.

Example 36 includes the subject matter of any one of Examples 32-35, and optionally, comprising receiving a pairing instruction via the docking interface, and, responsive to the pairing instruction, pairing between the docking device and the mobile device.

Example 37 includes the subject matter of any one of Examples 32-36, and optionally, comprising receiving the docking instructions from at least one input interface of the one or more user interface devices.

Example 38 includes the subject matter of Example 37, and optionally, wherein the at least one input interface comprises at least one interface selected from the group consisting of a keyboard, a mouse, a touch screen, and a touchpad.

Example 39 includes the subject matter of any one of Examples 32-38, and optionally, comprising instructing the one or more user interface devices to output the docking interface by at least one output interface of the one or more user interface devices.

Example 40 includes the subject matter of Example 39, and optionally, comprising instructing the output interface to output one or more docking messages.

Example 41 includes the subject matter of Example 39 or 40, and optionally, wherein the at least one output interface comprises at least one interface selected from the group consisting of a display, and an audio output unit.

Example 42 includes the subject matter of any one of Examples 32-41, and optionally, wherein the one or more user interface devices comprise a display, the method comprising instructing the display to display the docking interface.

Example 43 includes the subject matter of Example 42, and optionally, wherein the docking interface comprises one or more indicators to indicate a docking state of the docking device.

Example 44 includes the subject matter of Example 42 or 43, and optionally, wherein the docking interface comprises at least one command button, the method comprising controlling the docking device based on a state of the command button.

Example 45 includes the subject matter of Example 44, and optionally, wherein the at least one command button comprises at least one button selected from the group consisting of a pairing button, a connect button, and a disconnect button.

Example 46 includes the subject matter of any one of Examples 42-45, and optionally, wherein the display comprises a touch screen, the method comprises receiving the docking instructions via the touch screen.

Example 47 includes the subject matter of any one of Examples 42-46, and optionally, comprising instructing the display to display a ready to connect message.

Example 48 includes the subject matter of any one of Examples 42-47, and optionally, wherein the one or more user interface devices comprise one or more Human Interface Devices (HID).

Example 49 includes a product including one or more tangible computer-readable non-transitory storage media comprising computer-executable instructions operable to, when executed by at least one computer processor, enable the at least one computer processor to implement a method at a docking device, the method comprising instructing one or more user interface devices to output a docking interface; receiving one or more docking instructions via the docking interface; and based on the docking instructions, connecting the user interface devices as peripheral devices to a mobile device via a wireless communication link between the docking device and the mobile device.

Example 50 includes the subject matter of Example 49, and optionally, wherein the method comprises instructing the one or more user interface devices to perform the functionality of the docking interface, and, upon connection of the docking device to the mobile device, switching the interface devices to perform the functionality of the peripheral devices.

Example 51 includes the subject matter of Example 50, and optionally, wherein the method comprises monitoring user input to at least one of the peripheral devices, and, based on the user input, switching the user interface devices to perform the functionality of the docking interface.

Example 52 includes the subject matter of Example 50 or 51, and optionally, wherein the method comprises switching the user interface devices to perform the functionality of the docking interface, upon disconnection of the wireless communication link.

Example 53 includes the subject matter of any one of Examples 49-52, and optionally, wherein the method comprises receiving a pairing instruction via the docking interface, and, responsive to the pairing instruction, pairing between the docking device and the mobile device.

Example 54 includes the subject matter of any one of Examples 49-53, and optionally, wherein the method comprises receiving the docking instructions from at least one input interface of the one or more user interface devices.

Example 55 includes the subject matter of Example 54, and optionally, wherein the at least one input interface comprises at least one interface selected from the group consisting of a keyboard, a mouse, a touch screen, and a touchpad.

Example 56 includes the subject matter of any one of Examples 49-55, and optionally, wherein the method comprises instructing the one or more user interface devices to output the docking interface by at least one output interface of the one or more user interface devices.

Example 57 includes the subject matter of Example 56, and optionally, wherein the method comprises instructing the output interface to output one or more docking messages.

Example 58 includes the subject matter of Example 56 or 57, and optionally, wherein the at least one output interface comprises at least one interface selected from the group consisting of a display, and an audio output unit.

Example 59 includes the subject matter of any one of Examples 49-58, and optionally, wherein the one or more user interface devices comprise a display, the method comprising instructing the display to display the docking interface.

Example 60 includes the subject matter of Example 59, and optionally, wherein the docking interface comprises one or more indicators to indicate a docking state of the docking device.

Example 61 includes the subject matter of Example 59 or 60, and optionally, wherein the docking interface comprises at least one command button, the method comprising controlling the docking device based on a state of the command button.

Example 62 includes the subject matter of Example 61, and optionally, wherein the at least one command button comprises at least one button selected from the group consisting of a pairing button, a connect button, and a disconnect button.

Example 63 includes the subject matter of any one of Examples 59-62, and optionally, wherein the display comprises a touch screen, the method comprises receiving the docking instructions via the touch screen.

Example 64 includes the subject matter of any one of Examples 59-63, and optionally, wherein the method comprises instructing the display to display a ready to connect message.

Example 65 includes the subject matter of any one of Examples 49-64, and optionally, wherein the one or more user interface devices comprise one or more Human Interface Devices (HID).

Example 66 includes a docking device comprising means for instructing one or more user interface devices to output a docking interface; means for receiving one or more docking instructions via the docking interface; and means for, based on the docking instructions, connecting the user interface devices as peripheral devices to a mobile device via a wireless communication link between the docking device and the mobile device.

Example 67 includes the subject matter of Example 66, and optionally, comprising means for instructing the one or more user interface devices to perform the functionality of the docking interface, and, upon connection of the docking device to the mobile device, switching the interface devices to perform the functionality of the peripheral devices.

Example 68 includes the subject matter of Example 67, and optionally, comprising means for monitoring user input to at least one of the peripheral devices, and, based on the user input, switching the user interface devices to perform the functionality of the docking interface.

Example 69 includes the subject matter of Example 67 or 68, and optionally, comprising means for switching the user interface devices to perform the functionality of the docking interface, upon disconnection of the wireless communication link.

Example 70 includes the subject matter of any one of Examples 66-69, and optionally, comprising means for receiving a pairing instruction via the docking interface, and, responsive to the pairing instruction, pairing between the docking device and the mobile device.

Example 71 includes the subject matter of any one of Examples 66-70, and optionally, comprising means for receiving the docking instructions from at least one input interface of the one or more user interface devices.

Example 72 includes the subject matter of Example 71, and optionally, wherein the at least one input interface comprises at least one interface selected from the group consisting of a keyboard, a mouse, a touch screen, and a touchpad.

Example 73 includes the subject matter of any one of Examples 66-72, and optionally, comprising means for instructing the one or more user interface devices to output the docking interface by at least one output interface of the one or more user interface devices.

Example 74 includes the subject matter of Example 73, and optionally, comprising means for instructing the output interface to output one or more docking messages.

Example 75 includes the subject matter of Example 73 or 74, and optionally, wherein the at least one output interface comprises at least one interface selected from the group consisting of a display, and an audio output unit.

Example 76 includes the subject matter of any one of Examples 66-75, and optionally, wherein the one or more user interface devices comprise a display, the docking device comprising means for instructing the display to display the docking interface.

Example 77 includes the subject matter of Example 76, and optionally, wherein the docking interface comprises one or more indicators to indicate a docking state of the docking device.

Example 78 includes the subject matter of Example 76 or 77, and optionally, wherein the docking interface comprises at least one command button, the docking device comprising means for controlling the docking device based on a state of the command button.

Example 79 includes the subject matter of Example 78, and optionally, wherein the at least one command button comprises at least one button selected from the group consisting of a pairing button, a connect button, and a disconnect button.

Example 80 includes the subject matter of any one of Examples 76-79, and optionally, wherein the display comprises a touch screen, the docking device comprises means for receiving the docking instructions via the touch screen.

Example 81 includes the subject matter of any one of Examples 66-80, and optionally, comprising means for instructing the display to display a ready to connect message.

Example 82 includes the subject matter of any one of Examples 66-81, and optionally, wherein the one or more user interface devices comprise one or more Human Interface Devices (HID).

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A wireless docking device comprising:
a radio to communicate with a mobile device; and
a docking controller to instruct one or more user interface devices to output a docking interface, to receive one or more docking instructions via said docking interface, and, based on said docking instructions, to connect said user interface devices as peripheral devices to said mobile device via a wireless communication link between said radio and said mobile device.

2. The wireless docking device of claim 1, wherein said docking controller is to instruct said one or more user interface devices to perform the functionality of said docking interface, and, upon connection to said mobile device, to switch said interface devices to perform the functionality of said peripheral devices.

3. The wireless docking device of claim 2, wherein said docking controller is to monitor user input to at least one of said peripheral devices, and, based on said user input, to switch said user interface devices to perform the functionality of said docking interface.

4. The wireless docking device of claim 2, wherein said docking controller is to switch said user interface devices to perform the functionality of said docking interface, upon disconnection of said wireless communication link.

5. The wireless docking device of claim 1, wherein said docking controller is to receive a pairing instruction via the docking interface, and, responsive to the pairing instruction, to pair between the docking device and the mobile device.

6. The wireless docking device of claim 1, wherein said docking controller is to receive said docking instructions from at least one input interface of said one or more user interface devices.

7. The wireless docking device of claim 1, wherein said docking controller is to instruct said one or more user interface devices to output said docking interface by at least one output interface of said one or more user interface devices.

8. The wireless docking device of claim 7, wherein said docking controller is to instruct said output interface to output one or more docking messages.

9. The wireless docking device of claim 1, wherein said one or more user interface devices comprise a display, the docking controller to instruct said display to display said docking interface.

10. The wireless docking device of claim 9, wherein said docking interface comprises one or more indicators to indicate a docking state of said docking device.

11. The wireless docking device of claim 9, wherein said docking interface comprises at least one command button, said docking controller to control said docking device based on a state of said command button.

12. The wireless docking device of claim 9, wherein said display comprises a touch screen, said docking interface to receive said docking instructions via said touch screen.

13. The wireless docking device of claim 1 being integrated as part of one of said one or more user interface devices.

14. The wireless docking device of claim 1 comprising:
one or more antennas;
a memory; and
a processor.

15. A docking display device comprising:
a screen;
one or more antennas;
a radio to communicate with a mobile device; and
a docking controller to control said screen to display a virtual docking interface, to receive one or more docking instructions via said virtual docking interface, and, based on said one or more docking instructions to connect the docking display device as a peripheral device to said mobile device via a wireless communication link between said radio and said mobile device.

16. The docking display device of claim 15, wherein said docking controller is to receive a pairing instruction via the docking interface, and, responsive to the pairing instruction, to pair between the docking display device and the mobile device.

17. The docking display device of claim 15, wherein said docking controller is to instruct said screen to display one or more docking messages of said docking interface.

18. The docking display device of claim 15, wherein said docking interface comprises at least one command button, said docking controller to control said docking display device based on a state of said command button.

19. The docking display device of claim 15, wherein said screen comprises a touch screen, said docking interface to receive said docking instructions via said touch screen.

20. A method of wireless docking to be performed at a docking device, the method comprising:
instructing one or more user interface devices to output a docking interface;
receiving one or more docking instructions via said docking interface; and
based on said docking instructions, connecting said user interface devices as peripheral devices to a mobile device via a wireless communication link between said docking device and said mobile device.

21. The method of claim 20 comprising instructing said one or more user interface devices to perform the functionality of said docking interface, and, upon connection of said docking device to said mobile device, switching said interface devices to perform the functionality of said peripheral devices.

22. A product including one or more tangible computer-readable non-transitory storage media comprising computer-executable instructions operable to, when executed by at least one computer processor, enable the at least one computer processor to implement a method at a docking device, the method comprising:
instructing one or more user interface devices to output a docking interface;
receiving one or more docking instructions via said docking interface; and
based on said docking instructions, connecting said user interface devices as peripheral devices to a mobile device via a wireless communication link between said docking device and said mobile device.

23. The product of claim 22, wherein the method comprises instructing said one or more user interface devices to perform the functionality of said docking interface, and, upon connection of said docking device to said mobile device, switching said interface devices to perform the functionality of said peripheral devices.

24. The product of claim 22, wherein the method comprises receiving said docking instructions from at least one input interface of said one or more user interface devices.

25. The product of claim 22, wherein the method comprises instructing said one or more user interface devices to output said docking interface by at least one output interface of said one or more user interface devices.
